(19) United States
(12) Patent Application Publication
(10) Pub. No.: US 2016/0148257 A1
(43) Pub. Date: May 26, 2016

(54) SYSTEMS AND METHODS FOR RECOMMENDING VACATION OPTIONS BASED ON HISTORICAL VACATION DATA

(71) Applicant: MasterCard International Incorporated, Purchase, NY (US)

(72) Inventors: Pedro J. Chavarria, New York, NY (US); Kristofer Perez, New York, NY (US)

(21) Appl. No.: 14/554,756

(22) Filed: Nov. 26, 2014

(51) Int. Cl. G06Q 30/02; G06Q 20/34; G06Q 50/14

(52) U.S. Cl. CPC G06Q 30/0255; G06Q 50/14; G06Q 20/34

(57) ABSTRACT

A computer-implemented method for recommending vacation options based on historical vacation data is implemented by a vacation recommendation computer device. The method includes receiving a plurality of transaction data associated with a cardholder, identifying vacation transaction data from the plurality of transaction data, processing the vacation transaction data to determine a plurality of cardholder vacation characteristics, determining a vacation profile based on the plurality of cardholder vacation characteristics, identifying a plurality of cardholders with associated vacation profiles that match the vacation profile, receiving a plurality of vacation options including at least one vacation attribute, retrieving a vacation history associated with each of the identified plurality of cardholders, identifying at least one vacation option responsive to the cardholder by comparing the plurality of cardholder vacation characteristics to the at least one vacation attribute, and recommending the at least one identified vacation option to the cardholder.

### BACKGROUND OF THE DISCLOSURE

The field of the disclosure relates generally to recommending purchasing decisions to consumers based on consumer analytics, and more specifically to methods and systems for recommending vacation options based on historical travel by a consumer.

At least some consumers are interested in traveling for vacation purposes. Travel merchants may sell or otherwise provide services for vacation travel to such consumers in the form of vacation travel packages. These travel merchants may sell a variety of vacation travel packages to a variety of destinations. These vacation travel packages may be targeted at consumers with specific interests and lifestyles. For instance, vacation travel packages to the same geographic region at the same time of year may alternately target travelers interested in golf, outdoor sports, and beach relaxation. In many examples, merchants may face difficulty in advertising appropriate vacation travel packages to such consumers because consumers may have varying interests and lifestyles, varying schedules, and varying budgets. If merchants were able to identify consumers that have interest in particular vacation travel packages in an effective manner, merchants may be able to sell vacation travel packages at higher rates. Further, consumers may benefit from being targeted with vacation travel packages that correspond with at least their interests, lifestyles, schedules, and budgets.

### BRIEF DESCRIPTION OF THE DISCLOSURE

In one aspect, a computer-implemented method for recommending vacation options based on historical vacation data is provided. The method is implemented by a vacation recommendation computer device in communication with a memory. The method includes receiving a plurality of transaction data associated with a cardholder, identifying, by the vacation recommendation computer device, vacation transaction data from the plurality of transaction data, processing the vacation transaction data to determine a plurality of cardholder vacation characteristics, determining a vacation profile based on the plurality of cardholder vacation characteristics, identifying a plurality of other cardholders with associated vacation profiles corresponding to the vacation profile based on a second plurality of transaction data associated with the plurality of other cardholders, receiving a plurality of vacation options including at least one vacation attribute, retrieving a vacation history associated with each of the identified plurality of other cardholders, wherein each vacation history includes a plurality of previous vacation data, identifying, by the vacation recommendation computer device, at least one vacation option responsive to the cardholder by comparing the plurality of cardholder vacation characteristics to the at least one vacation attribute, wherein the at least one vacation option corresponds to at least a portion of the plurality of previous vacation data, and recommending the at least one identified vacation option to the cardholder.

In another aspect, a vacation recommendation computer device used to recommend vacation options based on historical vacation data is provided. The vacation recommendation computer device includes a processor, and a memory coupled to the processor. The vacation recommendation computer device is configured to receive a plurality of transaction data associated with a cardholder, identify vacation transaction data from the plurality of transaction data, process the vacation transaction data to determine a plurality of cardholder vacation characteristics, determine a vacation profile based on the plurality of cardholder vacation characteristics, identify a plurality of other cardholders with associated vacation profiles corresponding to the vacation profile based on a second plurality of transaction data associated with the plurality of other cardholders, receive a plurality of vacation options including at least one vacation attribute, retrieve a vacation history associated with each of the identified plurality of other cardholders, wherein each vacation history includes a plurality of previous vacation data, identify at least one vacation option responsive to the cardholder by comparing the plurality of cardholder vacation characteristics to the at least one vacation attribute, wherein the at least one vacation option corresponds to at least a portion of the plurality of previous vacation data, and recommend the at least one identified vacation option to the cardholder.

In a further aspect, computer-readable storage media for recommending vacation options based on historical vacation data is provided. The computer-readable storage media has computer-executable instructions embodied thereon. When executed by at least one processor, the computer-executable instructions cause the processor to receive a plurality of transaction data associated with a cardholder, identify vacation transaction data from the plurality of transaction data, process the vacation transaction data to determine a plurality of cardholder vacation characteristics, determine a vacation profile based on the plurality of cardholder vacation characteristics, identify a plurality of other cardholders with associated vacation profiles corresponding to the vacation profile based on a second plurality of transaction data associated with the plurality of other cardholders, receive a plurality of vacation options including at least one vacation attribute, retrieve a vacation history associated with each of the identified plurality of other cardholders, wherein each vacation history includes a plurality of previous vacation data, identify at least one vacation option responsive to the cardholder by comparing the plurality of cardholder vacation characteristics to the at least one vacation attribute, wherein the at least one vacation option corresponds to at least a portion of the plurality of previous vacation data, and recommend the at least one identified vacation option to the cardholder.

### BRIEF DESCRIPTION OF THE DRAWINGS

The figures listed below show example embodiments of the methods and systems described herein.

FIGS. 1-10 show example embodiments of the methods and systems described herein.

FIG. 1 is a schematic diagram illustrating an example multi-party payment card system for enabling payment-by-card transactions and recommending vacation options to cardholders in accordance with one embodiment of the present disclosure.

FIG. 2 is an expanded block diagram of an example embodiment of a computer system used in processing payment transactions that includes a vacation recommendation computer device in accordance with one example embodiment of the present disclosure.

FIG. 3 illustrates an is an expanded block diagram of an example embodiment of a computer device architecture of a system used to recommend vacation options to cardholders in accordance with one example embodiment of the present disclosure.

FIG. 4 illustrates an example configuration of a device such as the vacation recommendation computer device of FIGS. 2 and 3 used to recommend vacation options in accordance with one example embodiment of the present disclosure.

FIG. 5 is a simplified data flow diagram of recommending vacation options using the vacation recommendation computer device of FIGS. 2 and 3.

FIG. 6 is a block diagram of an example relationship between cardholders, merchants, and categories that are created and used by the vacation recommendation computer device based on purchases made by cardholders from merchants.

FIG. 7 is a block diagram of an example relationship between categories of cardholders and interests associated with the categories created by the vacation recommendation computer device.

FIG. 8 is a simplified diagram of an example method of recommending vacation options using the vacation recommendation computer device of FIGS. 2 and 3.

FIG. 9 is a simplified diagram of a further example method of recommending vacation options using the vacation recommendation computer device of FIGS. 2 and 3.

FIG. 10 is a diagram of components of one or more example computing devices that may be used in the environment shown in FIG. 6.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

In at least some cardholder-initiated payment transactions, a cardholder (e.g., a person or entity using a payment card such as a credit card, a debit card, or a prepaid card) may purchase goods and services (“products”). Such payment transactions include transaction data generated during the payment transaction. By processing transaction data for a cardholder, cardholder characteristics may be determined that may assist in determining interests, lifestyles, schedules, and budgets of the cardholder. By processing such transaction data, the systems and methods described herein may identify or define a cardholder vacation profile that may further be used to recommend at least one vacation option to a cardholder.

In further examples, cardholders may seek vacation options that are somewhat similar to previous vacations taken by the cardholder. Although some details such as location may vary, cardholders may frequently seek similar types of experiences in vacations or similar types of accommodations. In at least some cardholder-initiated payment transactions, a cardholder may make purchases of goods and services while on vacation (“vacation transactions”). As described below and herein, vacation transactions may be distinguished from other payment transactions based at least in part on the location of merchants and the categories of merchants associated with the vacation transactions. Vacation transactions generate vacation transaction data which is part of, or included within ordinary payment transaction data. Such vacation transaction data may be analyzed to determine what characteristics a particular cardholder may want in vacation options.

Accordingly, the systems and methods described herein facilitate the recommendation of vacation options based on transaction data and based on previous vacations. In a first example embodiment, the systems and methods recommend vacation options based on transaction data. Such systems and methods are implemented using a computing device known as a vacation recommendation computer device. The vacation recommendation computer device includes a processor in communication with a memory. The vacation recommendation computer device is configured to: (i) receive a plurality of transaction data associated with a cardholder, (ii) process the plurality of transaction data to determine a plurality of cardholder vacation characteristics, (iii) receive a plurality of vacation options including at least one vacation attribute, (iv) identify at least one vacation option responsive to the cardholder by comparing the plurality of cardholder vacation characteristics to the at least one vacation attribute, and (v) recommend the at least one identified vacation option to the cardholder.

In other example embodiments, the systems and methods described herein facilitate the recommendation of vacation options based on previous vacations. In these other embodiments, the systems and methods described are also implemented using the vacation recommendation computer device. In such embodiments, the vacation recommendation computer device is configured to: (i) receive a plurality of transaction data associated with a cardholder, (ii) identify vacation transaction data from the plurality of transaction data, (iii) process the vacation transaction data to determine a plurality of cardholder vacation characteristics, (iv) determine a vacation profile based on the plurality of cardholder vacation characteristics, (v) identify a plurality of other cardholders with associated vacation profiles corresponding to the vacation profile based on a second plurality of transaction data associated with the plurality of other cardholders, (vi) receive a plurality of vacation options including at least one vacation attribute, (vii) retrieve a vacation history associated with each of the identified plurality of other cardholders, wherein each vacation history includes a plurality of previous vacation data, (viii) identify at least one vacation option responsive to the cardholder by comparing the plurality of cardholder vacation characteristics to the at least one vacation attribute, wherein the at least one vacation option corresponds to at least a portion of the plurality of previous vacation data, and (ix) recommend the at least one identified vacation option to the cardholder.

The vacation recommendation computer device receives a plurality of transaction data associated with a cardholder. Transaction data is generated as a result of a plurality of consumer transactions initiated by the cardholder. In the example embodiment, transaction data is received at the payment network (i.e., interchange network). In alternative embodiments, transaction data is received from memory or a storage device that previously received the transaction data from the interchange network. At least some transaction data is associated with vacation transactions (i.e., cardholder transactions made for, during, or to otherwise facilitate a vacation) and may be referred to as “vacation transaction data”. Alternately, transaction data may include ordinary transaction data (i.e. transaction data that is not vacation transaction data).

In one embodiment, vacation transaction data is used to determine cardholder vacation characteristics as vacation transaction data directly indicates actual cardholder vacation preferences and cardholder vacation behaviors. Alternately, ordinary transaction data may also be used to determine cardholder vacation characteristics including cardholder vacation preferences and cardholder vacation behaviors. For instance, as described herein, such ordinary transaction data may indicate general cardholder preferences and cardholder behaviors that may be used to determine cardholder vacation preferences and cardholder vacation behaviors. As described below, all such transaction data (i.e, ordinary transaction data and vacation transaction data) may be used to identify such cardholder vacation characteristics that may be stored in a cardholder vacation profile. As used herein, a cardholder vacation profile is a representation of expected cardholder vacation preferences, interests, and behaviors. Such cardholder vacation profiles and cardholder vacation characteristics are used to facilitate the recommendation of vacation options to cardholders.

Transaction data (including ordinary transaction data and vacation transaction data) may include a plurality of elements that define or describe each cardholder transaction. In the example embodiment, each element of the plurality of transaction data includes at least a transaction date, a transaction location, a merchant identifier, a merchant category, and a transaction value. As described below, such transaction data may be aggregated and processed to determine transaction characteristics associated with the cardholder. Such transaction characteristics may describe cardholder behaviors and preferences associated with the cardholder, generally. In at least one example, transaction data may include data as shown below (Table 1):

TABLE 1

| | Trans. | | | | | |
|---|---|---|---|---|---|---|
| Cardholder | Data | Trans. | Trans. | Merchant | Merchant | Trans. |
| ID | Type | Date/Time | Location | ID | Cat. | Value |
| ABC123 | Ordinary | Jun. 1, | Anytown, | Colorado | Sports | $400 |
| | | 2020 | Colorado | Bikes | Equipment - | |
| | | | | | Bicycles | |
| ABC123 | Ordinary | Jul. 4, | Anytown, | Colorado | Sports | $800 |
| | | 2020 | Coloardo | Kayaks | Equipment - | |
| | | | | | Boats | |
| ABC123 | Ordinary | Jul. 24, | Anytown, | Colorado | Sports | $100 |
| | | 2020 | Colorado | Runners | Equipment - | |
| | | | | | Apparel | |
| ABC123 | Vacation | Aug. 1, | Anyplace, | Colorado | Sports | $200 |
| | | 2020 | Colorado | Bicycles | Recreation - | |
| | | | | | Resort | |
| BCD234 | Vacation | Jun. 1, | Somewhere, | Andean | Sports | $600 |
| | | 2020 | Chile | Mountain | Recreation - | |
| | | | | Resort | Skiing | |
| BCD234 | Vacation | Dec. | Ski Village, | Utah | Sports | $500 |
| | | 1, 2020 | Utah | Skiing | Recreation - | |
| | | | | | Skiing | |

In the example shown in Table 1, Cardholder ABC123 is associated with ordinary transactions and vacations transactions and therefore generates ordinary transaction data and vacation transaction data. All ABC123 transactions are tied to outdoor fitness activities. Based on ordinary transaction data, vacation recommendation computer device may identify Cardholder ABC123 as a resident of Colorado because associated transactions occur within Colorado. Further, Cardholder ABC123 has vacation transaction data within Colorado. Therefore Cardholder ABC123 may be interested in vacation options (i.e., may have a cardholder preference) involving outdoor activities in or near Colorado. As a result, as described below, Cardholder ABC123 may be identified by the vacation recommendation computer device as having a cardholder vacation profile that is associated with short distance travel in or near Colorado and outdoor fitness activities. The vacation recommendation computer device may accordingly recommend vacation options related to outdoor fitness in or near Colorado.

Alternately, Cardholder BCD234 is associated with only vacation transaction data. The vacation transaction data is associated with two distinct regions—Chile and Utah. Because of the timing of the purchases, vacation recommendation computer device determines Cardholder BCD234 travels to alternate hemispheres for winter vacations (as the local definition of winter varies by hemisphere) in order to ski. Such patterns may be used to determine part of Cardholder BCD234's actual cardholder vacation behavior. As a result, vacation recommendation computer device determines Cardholder BCD234 is interested in vacations involving travel for winter sports even when the vacation requires significant distances of travel. Cardholder BCD234 may be identified by the vacation recommendation computer device as having a cardholder vacation profile that is associated with expensive travel for winter sports.

In a similar manner, transaction data such as that shown in Table 1 may be used to determine typical vacation budgets or projected budgets. For example, Cardholder BCD234 appears to spend at least $500 at ski vacation locations. The vacation recommendation computer device may be configured to search for other vacation transaction data (e.g., airline transactions, restaurant transactions, and hotel transactions) at times near each vacation to determine a vacation budget. In the example of Cardholder ABC123, ordinary transaction data may also be processed to determine the cardholder's available resources for vacation travel. For example, by compiling all ordinary transaction data associated with the purpose of vacations (e.g., all outdoor sporting transaction data for Cardholder ABC123), an indication of cardholder's willingness to spend on an activity may be determined and used to calculate a vacation budget.

Vacation recommendation computer device additionally is configured to identify vacation transaction data as distinct from ordinary transaction data. As described herein, although all transaction data may be used to determine cardholder vacation characteristics, vacation transaction data may serve as a useful indicator of cardholder vacation behavior and cardholder vacation preferences because it reflects actual previous vacation travel. Identification of vacation transaction data from transaction data may be accomplished in a variety of methods.

In one example, the vacation recommendation computer device determines a primary region associated with the cardholder based on all transaction data. In the example embodiment, the primary region is a radius in which most of the cardholder transactions occur. As a result, the primary region is also a radius in which the cardholder spends a substantial amount of time. Accordingly, transactions that occur outside the primary region may be associated with potential vacations. The vacation recommendation computer device may review all transaction data for each cardholder and, depending on the associated merchant location (or transaction location) determine the locations of each transaction. As it is expected that cardholders most frequently make purchases near their homes, the most common locations of cardholder transactions may indicate the primary region associated with the cardholder. The vacation recommendation computer device may further identify transaction data from locations outside the primary region as potential vacation transaction data because the cardholder is making transactions away from home. In some examples, the vacation recommendation computer device may further only consider transactions a minimum distance away from the primary region to be potential vacation transaction data (to exclude semi-local travel unrelated to vacations). In one example, the vacation recommendation computer device specifically reviews card-present transactions (because in card-not-present transactions, the cardholder location may not be known). Specifically, the vacation recommendation computer device identifies transaction data associated with card-present transactions that are initiated by the cardholder at a merchant having a merchant location outside of the primary region.

In further examples, the vacation recommendation computer device may identify vacation transaction data based on the category of the associated merchant, or patronized merchant. For example, the vacation recommendation computer device may review merchant categories from transaction data to determine whether any merchant is identified with a category commonly associated with vacation travel (e.g., airline merchants, rental car merchants, hotel merchants, restaurant merchants, and entertainment merchants.) In one example, a vacation database stores a correlation table that associates merchant categories with potential vacation travel. Such a correlation table may also indicate that particular merchant categories are more or less likely to be associated with vacation travel. For example, a merchant category of a resort destination may be very likely to be associated with vacation travel while a rental car may be somewhat likely to be associated with vacation travel. In some examples, such correlation tables may also indicate the likelihood of association with vacation travel using a numeric indicator or score. In one example, the vacation recommendation computer system identifies a plurality of patronized merchant categories associated with each transaction included within the transaction data for the cardholder, defines vacation merchant categories included within the plurality of patronized merchant categories wherein vacation merchant categories are categories of merchants that are associated with vacation travel, and identifies transaction data included within the vacation merchant categories as vacation transaction data.

In many examples, the vacation recommendation computer device also aggregates multiple transactions from a time period to identify vacation transaction data. Ordinarily, cardholders will make multiple transactions in a particular location. Accordingly, the vacation recommendation computer device may determine that several transactions occur outside of a primary region and are further associated with merchant categories that are likely to be associated with vacation travel. By processing multiple transactions in such a manner, the vacation recommendation computer device may more accurately distinguish ordinary transaction data from vacation transaction data.

The vacation recommendation computer device is also configured to aggregate and process all transaction data (i.e., vacation transaction data and ordinary transaction data) to determine a plurality of cardholder vacation characteristics associated with each cardholder. As described, such cardholder vacation characteristics may describe cardholder vacation behaviors and vacation preferences. In other words, by processing transaction data elements from all transaction data, the vacation recommendation computer device determines cardholder vacation preferences and cardholder vacation behaviors that are stored as cardholder vacation characteristics. Such cardholder vacation characteristics may further be stored in a cardholder vacation profile.

As described cardholder vacation profiles represent a plurality of cardholder vacation characteristics. Such cardholder vacation characteristics may include, for example and without limitation, a preferred vacation schedule (i.e., preferred time periods for vacations), preferred geographic regions of interest for vacations, projected budgets for vacations, primary purposes for vacations, expected duration of vacations, and preferred social characteristics of vacations (e.g., “family friendly” vacations, adventure vacations, and urban vacations.) In an illustrative example, Cardholders ABC123 and BCD234 of Table 1 may have the following cardholder vacation profiles as shown below (Table 2):

TABLE 2

| | Preferred | Preferred | Projected | | | |
|---|---|---|---|---|---|---|
| Cardholder | Vacation | Geographic | Vacation | Primary | | Social |
| ID | Schedule | Regions | Budget | Purpose | Duration | Chars. |
| ABC123 | June- | Rocky | $500 | Outdoors | 1 week | Adventure |
| | August | Mountains | | | | |
| BCD234 | Local | Anywhere | $2000 | Skiing | 2 weeks | Resort |
| | Winter | | | | | Skiing |

The vacation recommendation computer device may use multiple methods of determining cardholder vacation characteristics and cardholder vacation profiles. In a first example embodiment, a method may be used to process vacation transaction data when available. The vacation recommendation computer device may identify cardholder vacation behaviors and preferences by analyzing and processing such vacation transaction data. For example, regions of interest may be identified based on the locations of vacation transaction data. The preferred vacation schedule may be determined based on the typical time of travel in vacation transaction data. Similarly, a projected vacation budget, primary purpose, duration, and social characteristics may be determined based on vacation transaction data.

Alternately, the vacation recommendation computer device may determine cardholder vacation characteristics by comparing vacation transaction data to known data sets. In a first example, vacation transaction data is processed using a vacation database containing information associated with particular merchant identifiers, merchant categories, and merchant locations. Some data in the vacation database may be generated using external data including, for example, internet review webpages for merchants and websites for merchants. Alternately, the vacation database may be generated using cardholder review data provided in response to cardholder transactions. In either example, particular merchant identifiers may be correlated with subjective or objective ratings derived from the external data. Based on such external data, a particular resort merchant may be known to be associated with “family vacations” while another resort merchant is associated with “elite vacations”. Therefore, vacation transaction data may be used to allow the vacation recommendation computer device to determine that a cardholder prefers “elite vacations” based on merchant identifiers indicated in that cardholder's vacation transaction data.

The vacation database may also include tables that correlate merchant categories to particular cardholder vacation characteristics. For example, in the examples of Table 1 and Table 2, the merchant categories associated with Cardholder ABC123 may indicate that Cardholder ABC123 has seeks vacation travel with a primary purpose of “Outdoors” and social characteristics of “Adventure”. Similarly, other merchant categories or groupings of merchant categories may be correlated to relevant cardholder vacation characteristics. Such a correlation table may be generated based on external data, analytics of transaction data, or any other suitable means.

The vacation database also may include tables that correlate merchant locations to particular cardholder vacation characteristics. In some examples, when merchant locations are within a constrained area, a cardholder may simply have a preferred geographic region of that constrained area. Such a preferred geographic region may be referred to as a “region of interest.” However, in other examples, additional characteristics of merchant locations may be considered to identify common characteristics related to the combination of merchant locations. In one example, a cardholder who vacations principally in Miami may have a preferred geographic region assigned to them of Miami or southern Florida. In a second example, a cardholder vacations regularly in Miami, San Diego, Cancun, and Honolulu. The vacation database may identify that all such locations are associated with beaches. Therefore the vacation recommendation computer device may determine that the cardholder of the second example has a preferred geographic region of areas that includes beaches. In a similar manner, the correlation tables may identify merchant locations associated with varying characteristics including, for example and without limitation, particular language groups (e.g., the preferred geographic region may be English speaking nations), cultural or historical associations (e.g., the preferred geographic region may be locations with notable ancient history), and lifestyle (e.g., the preferred geographic region may be locations with available gambling or gaming). The correlation tables may similarly be used to associate merchant locations with primary purposes and social characteristics. In some examples, the vacation recommendation computer system may identify a vacation region of interest for the cardholder based on the vacation transaction data, wherein the vacation region of interest represents at least one geographic location in which the cardholder is interested in vacation travel.

In other examples, the vacation recommendation computer device may determine cardholder vacation characteristics by comparing the vacation transaction data to vacation transaction data for other cardholders at similar vacation activities. In such examples, the vacation recommendation computer device may first assign a subset of vacation transaction data with a specific vacation identity such as “June 2020 trip to Buenos Aires”. Thus all vacation transaction data for this subset may be used and compared to other corresponding vacation transaction data for other cardholders. For example, when vacation transaction data from a subset for a particular cardholder indicates the cardholder spends at substantially higher rates than other cardholders associated with similar vacation activities (e.g., a trip to Buenos Aires in June of 2020), the vacation recommendation computer device may determine that the particular cardholder has a preference for elite or premium services. Alternately, the vacation recommendation computer device may determine that the cardholder prefers, for example, longer vacations than is typical, more entertainment than is typical, a higher overall vacation budget than is typical, or any other identifiable distinction.

In some examples, a cardholder may include multiple vacation sub-profiles within their cardholder vacation profile. Specifically, a cardholder may be interested in vacation types and have varying schedules, primary purposes, preferred geographic regions, projected vacation budgets, durations, and social characteristics for each. In one example, a cardholder may be more likely to spend more money in a particular location than other locations. A cardholder that regularly travels to Las Vegas and Boulder may have a significantly higher vacation budget in Las Vegas than Boulder. Alternately, a cardholder may spend more money on a family vacation than an adventure vacation. Accordingly, the vacation recommendation computer device is configured to identify such distinctions within cardholder vacation profiles to identify such sub-profiles.

In some examples, a cardholder may only have ordinary transaction data (i.e., the cardholder does not have available vacation transaction data). In such examples, cardholder vacation characteristics (and therefore cardholder vacation profiles) may be determined using ordinary transaction data. In a first example, ordinary transaction data may be processed to determine an average expenditure (in a given period) for the cardholder to spend on particular recreation activities or recreation activities, generally. Recreation activities may be identified based on, for example, merchant identifiers and merchant categories using the vacation database. For example, the vacation recommendation computer device may identify that a cardholder purchases from merchant wine-sellers at a particular rate. The vacation recommendation computer device may therefore determine that the cardholder has cardholder vacation characteristics responsive to a vacation with a purpose of visiting wineries where the vacation budget is based on the particular rate of purchase from wine-sellers. The vacation recommendation computer device may further review ordinary transaction data to determine recreational or discretionary spending using the vacation database. The vacation database may indicate that certain merchant identifiers, merchant categories, and merchant locations are associated with recreational or discretionary spending in correlation tables.

The vacation recommendation computer device may also identify merchant categories frequently represented in the ordinary transaction data to determine at least one primary purpose for cardholder vacation travel. For example, if a cardholder purchases very frequently from golf courses, the vacation recommendation computer device may determine that the cardholder has a cardholder vacation profile such that a primary purpose of vacation is golfing.

In a similar manner, a cardholder vacation schedule may be determined based on historical transaction data. In one example, ordinary transaction data may be reviewed to determine when a cardholder has a pattern of expenditures that are not in the primary region of the cardholder (even if such expenditures are not associated with vacation transaction data). When such patterns repeat, the vacation recommendation computer may identify a cardholder vacation schedule because the cardholder is typically determined to be potentially on vacation at those times. In another example, ordinary transaction data may be reviewed to determine when a cardholder has a pattern of expenditures that are otherwise unusual. Such unusual time periods may be used by the vacation recommendation computer device to identify cardholder vacation schedules.

In a second example, ordinary transaction data for a particular cardholder is compared to ordinary transaction data for cardholders with vacation transaction data. When the ordinary transaction data for the particular cardholder substantially overlaps with ordinary transaction data for cardholders with vacation transaction data, the particular cardholder may be projected to have an equivalent cardholder vacation profile (and cardholder vacation characteristics) of the cardholders with vacation transaction data. In other words, the vacation recommendation computer device may identify cardholders with similar consumption characteristics (similar cardholders) to the particular cardholder and project that the particular cardholder has a cardholder vacation profile equivalent to the similar cardholders.

In a third example, the vacation recommendation computer device may include in the vacation database correlation tables that associate particular ordinary transaction data patterns with particular cardholder vacation characteristics. For example, certain spending patterns throughout the year may indicate that a cardholder is likely to spend more generally in certain months as compared to others. Such months may therefore be identified as potential time periods for vacation travel and used to define the cardholder vacation characteristics. Similarly, ordinary transaction data may indicate a change in quality of life for a cardholder and be used to indicate that the cardholder is interested in a vacation. In further examples, the vacation recommendation computer device may determine that such ordinary transaction data patterns indicate that the cardholder will be interested in a vacation in the immediate future but not as responsive at a later period.

A cardholder vacation type may also be determined based on historical transaction data. Specifically, the type or category of a preferred cardholder vacation may be determined based on the interests of the cardholder as indicated in the cardholder vacation profile. In some examples, the vacation recommendation computer device may also determine that the cardholder prefers a rotation of vacation types such that previous vacation types are not immediately repeated in recommended vacation options. In such examples, vacation types may be ranked but also provided in light of previous vacation types to avoid repetition. Other cardholders may be identified as not preferring such a rotation and may only receive the same vacation type until the cardholder vacation profile changes.

In some examples, even though vacation transaction data may be available, ordinary transaction data may be used to refine a cardholder vacation profile. For example, a particular cardholder may have a cardholder vacation profile indicating that the cardholder is interested in golfing vacations. The vacation recommendation computer device may determine that the particular cardholder has significantly increased consumption from golf related merchants in the past year and may update the cardholder vacation profile to indicate that the vacation budget may be higher than previously indicated based on vacation transaction data.

The vacation recommendation computer device also receives a plurality of vacation options. The vacation options represent vacation travel packages that may be marketed or advertised to consumers such as the cardholder. Each vacation option may be associated with at least one vacation attribute. Vacation attributes may include, for example and without limitation, vacation categorizations, vacation locations, vacation costs, vacation durations, and vacation schedules. For example, the vacation recommendation computer device may receive vacation options for outdoor vacations and skiing, as indicated below (Table 3):

TABLE 3

| Vacation | | | | | |
|---|---|---|---|---|---|
| Package | Vacation | Vacation | Vacation | Vacation | Vacation |
| Name | Cost | Location | Category | Duration | Schedule |
| River | $450 | Somewhere, | Outdoor | 1 week | June- |
| Wild | | Utah | Adventure | | August |
| Excursion | | | | | |
| Raging | $900 | Another- | Outdoor | 1 week | June- |
| Rivers | | place, | Adventure | | August |
| | | Florida | | | |

By comparing the cardholder vacation profile for Cardholder ABC123 in Table 2 to the vacation options in Table 3, it is apparent that Cardholder ABC123 will prefer the “River Wild Excursion” vacation option to the “Raging Rivers” vacation option because the vacation cost and vacation location of “River Wild Excursion” matches the cardholder vacation profile more closely. Accordingly, the vacation recommendation computer device is configured to identify vacation attributes from vacation options and use such vacation attributes to compare vacation options to cardholder vacation profiles.

The vacation recommendation computer device may receive vacation options from vacation merchants with vacation attributes explicitly identified as part of the received data set. Alternately, the vacation recommendation computer device may determine vacation attributes. In some examples, the vacation recommendation computer device may use search tools and the vacation database to identify vacation attributes. For example, the vacation recommendation computer device may be configured to perform a lookup for vacation attributes using database or Internet resources by using vacation option identifiers. Results from such a lookup may be parsed and defined as vacation attributes. In other examples, the vacation recommendation computer device may use algorithms to determine vacation attributes. For example, the vacation recommendation computer device may identify a vacation budget by using a forecasting algorithm.

The vacation recommendation computer device also identifies at least one vacation option responsive to the cardholder. More specifically, the vacation recommendation computer device compares the plurality of cardholder vacation characteristics to at least one vacation attribute. In some examples, vacation attributes may identically overlap with a particular cardholder vacation characteristic. For example, a vacation option cost may overlap with a cardholder vacation budget. In such examples, the vacation recommendation computer device may recommend vacation options with costs that are within cardholder vacation budgets. In other examples, vacation attributes may not fully overlap with cardholder vacation characteristics. For example, in some examples, a vacation attribute is not available that corresponds to a particular cardholder vacation characteristic. In such cases, the vacation recommendation computer device may project a potential vacation attribute.

In some examples, the vacation recommendation computer device may use quality scores to identify a vacation option that is responsive to a cardholder. More specifically, the vacation recommendation computer device may identify a plurality of vacation options and further identify a plurality of associated travel attributes. The vacation recommendation computer device may further compare the travel attributes to cardholder vacation characteristics and determine a quality score for each vacation option. The quality score reflects the degree or confidence of matching between the vacation option and the cardholder vacation characteristic. The vacation recommendation computer device may also rank the vacation options based on the quality scores. The vacation recommendation computer device may thus identify a vacation option to recommend to the cardholder at least partially based on the quality scores for the vacation options.

The vacation recommendation computer device additionally recommends the at least one vacation option to the cardholder. In one example, the vacation option is recommended by alerting the cardholder of the vacation option directly. In a second example, the vacation recommendation computer device sends a message to a merchant or an advertiser to inform the cardholder of the vacation option.

In some examples, the vacation recommendation computer device is configured to identify a vacation profile based on cardholder vacation transaction data and to further identify other cardholders with similar vacation profiles. Accordingly, the vacation recommendation computer device may recommend vacation options based on the previous vacation travel of such other cardholders.

In one example, the vacation recommendation computer device identifies and recommends vacation options based on the previous vacation travel of cardholders similar to a particular cardholder (i.e., cardholders with profiles that correspond to the particular cardholder). The vacation recommendation computer device receives a plurality of transaction data associated with a cardholder and identifies vacation transaction data from the plurality of transaction data. As described above and herein, such vacation transaction data may be processed by the vacation recommendation computer device to determine (or identify) a plurality of cardholder vacation characteristics. Based on such cardholder vacation characteristics, the vacation recommendation computer device determines a vacation profile for the particular cardholder. As described above and herein, the vacation profile represents a list of preferences for vacations detected for a particular cardholder based on transaction data and vacation transaction data. Further, to facilitate a similarity score (described below), each of the list of preferences for a particular cardholder may be weighted based on the significance of the preference to the cardholder or generally.

The vacation recommendation computer device also identifies cardholder vacation characteristics for other cardholders (i.e., cardholders that are not the particular cardholder) in the system. Based on such identified cardholder vacation characteristics, the vacation recommendation computer device may determine a vacation profile for each of the other cardholders. (In some examples, not all other cardholders are processed, but rather a sub-set that may be selected based on factors including country, region, cardholder demographics, and cardholder spending data.) The vacation recommendation computer device accordingly may compare the vacation profile of the particular cardholder to the vacation profiles of other cardholders to identify a subset of cardholders that have similar vacation interests and preferences to the particular cardholder.

In one example, the vacation recommendation computer device compares vacation profiles by comparing components of vacation profiles, and more specifically by comparing cardholder vacation characteristics. The vacation recommendation computer device determines a similarity score between the cardholder and other cardholders based on such a comparison. The similarity score is determined based on the number of corresponding cardholder vacation characteristics in both the cardholder and the potentially matching other cardholders. In some examples, weights may be assigned to particular cardholder vacation characteristics depending on the relative significance to the particular cardholder. For example, if the particular cardholder always travels in May and often travels at XYZ brand hotels, the characteristic of May travel may be weighted more heavily than the selection of XYZ brand hotels in comparisons to other cardholders. The vacation recommendation computer device determines a minimum similarity score above which other cardholders may be characterized as potentially matching. In at least some examples, cardholder vacation characteristics may match in partial or fuzzy manners. For example, the vacation recommendation computer device may determine that cardholder vacation characteristics of two cardholders are similar but not identical. In such an example, the partial match may be used to adjust the similarity score more than a non-match but less than an identical match.

Potentially matching cardholders with a minimum similarity score may be identified and flagged by the vacation recommendation computer device. The vacation recommendation computer device also receives a plurality of vacation options including at least one vacation attribute and retrieves a vacation history associated with each of the identified plurality of other cardholders (i.e., the subset of the other cardholders identified as having vacation profiles that match the particular cardholder), wherein each vacation history includes a plurality of previous vacation data.

In order for the particular cardholder to utilize previous travel information of similar cardholders, the vacation recommendation computer device identifies at least one vacation option responsive to the cardholder by comparing the plurality of cardholder vacation characteristics to the at least one vacation attribute, wherein the at least one vacation option corresponds to at least a portion of the plurality of previous vacation data. As a result, in such examples, the particular cardholder is directed to a vacation option that was utilized by at least one matching other cardholder. In some examples, vacation options may be weighted or scored more favorably when they are associated with repeated travel for other matching cardholders or associated with travel for several distinct matching cardholders. Based on such identification, the vacation recommendation computer device recommends the at least one identified vacation option to the cardholder.

Through the identification of vacation options based on transaction data, the systems and methods are further configured to facilitate (a) identifying relevant vacation options to cardholders, (b) reducing advertising costs spent by vacation merchants due to marketing to consumers that are less interested in particular vacation products, and (c) reduce time spent by cardholders in identifying relevant vacation options.

The technical effects of the systems and methods described herein can be achieved by performing at least one of the following steps: (a) receiving a plurality of transaction data associated with a cardholder; (b) processing, by the vacation recommendation computer device, the plurality of transaction data to determine a plurality of cardholder vacation characteristics; (c) receiving a plurality of vacation options including at least one vacation attribute; (d) identifying at least one vacation option responsive to the cardholder by comparing the plurality of cardholder vacation characteristics to the at least one vacation attribute; (e) recommending the at least one identified vacation option to the cardholder; (f) determining a cardholder vacation budget representing an amount the cardholder is likely to spend on vacation travel, by determining an average expenditure for the cardholder on recreation activities, and identifying the at least one vacation option by comparing the cardholder vacation budget to a plurality of option budgets each associated with one of the plurality of vacation options; (g) determining at least one merchant category wherein the cardholder has initiated multiple purchases, determining a cardholder vacation type representing a category of vacation travel in which the cardholder is interested based on the determined at least one merchant category, and identifying the at least one vacation option by comparing the cardholder vacation type to a plurality of option types each associated with one of the plurality of vacation options; (h) determining a cardholder vacation schedule representing a time period in which the cardholder is interested in vacation travel, based on historical transaction data, and identifying the at least one vacation option by comparing the cardholder vacation schedule to a plurality of option schedules associated with each of the plurality of vacation options; (i) identifying a plurality of vacation options, associating each identified vacation option with a quality score, and ranking the plurality of identified vacation options; (j) providing the plurality of identified vacation options to the cardholder based at least partially on the associated ranking; (k) providing the at least one vacation option to the cardholder by sending a message to at least one of a merchant and an advertiser; (l) receiving a plurality of transaction data associated with a cardholder; (m) identifying, by the vacation recommendation computer device, vacation transaction data from the plurality of transaction data; (n) processing the vacation transaction data to determine a plurality of cardholder vacation characteristics; (o) receiving a plurality of vacation options including at least one vacation attribute; (p) identifying at least one vacation option responsive to the cardholder by comparing the plurality of cardholder vacation characteristics to the at least one vacation attribute; (q) recommending the at least one identified vacation option to the cardholder; (r) determining a primary region associated with the cardholder based on the plurality of transaction data, wherein the primary region represents a location in which the cardholder spends a substantial amount of time, and identifying transaction data associated with card-present transactions that are initiated by the cardholder at a merchant having a merchant location outside of the primary region; (s) identifying a plurality of patronized merchant categories associated with each transaction included within the transaction data for the cardholder, defining vacation merchant categories included within the plurality of patronized merchant categories wherein vacation merchant categories are categories of merchants that are associated with vacation travel, and identifying transaction data included within the vacation merchant categories as vacation transaction data; (t) identifying a vacation region of interest for the cardholder based on the vacation transaction data, wherein the vacation region of interest represents at least one geographic location in which the cardholder is interested in vacation travel; (u) identifying a cardholder vacation schedule based on the vacation transaction data; (v) determining a cardholder vacation budget associated with the at least one vacation option; and (w) determining a primary purpose associated with the at least one vacation option.

The following detailed description of the embodiments of the disclosure refers to the accompanying drawings. The same reference numbers in different drawings may identify the same or similar elements. Also, the following detailed description does not limit the claims.

Described herein are computer systems such as vacation recommendation computer devices and consumer computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the identification of vacation travel for consumers based on information derived from payment transactions.

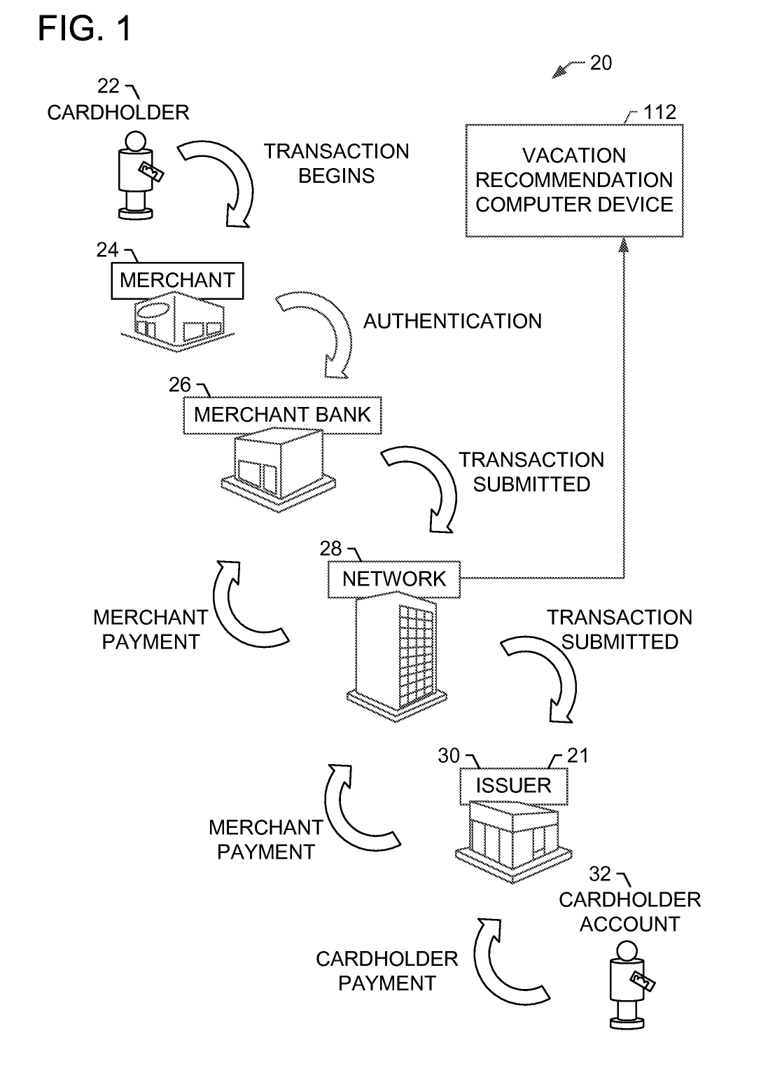

FIG. 1 is a schematic diagram illustrating an example multi-party transaction card system 20 for enabling payment-by-card transactions, and recommending vacation options to cardholders in accordance with one embodiment of the present disclosure, in which merchants 24 and card issuers 30 do not need to have a one-to-one special relationship. Typical financial transaction institutions provide a suite of interactive, online applications to both current and prospective customers. For example, a financial transactions institution may have a set of applications that provide informational and sales information on their products and services to prospective customers, as well as another set of applications that provide account access for existing cardholders.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

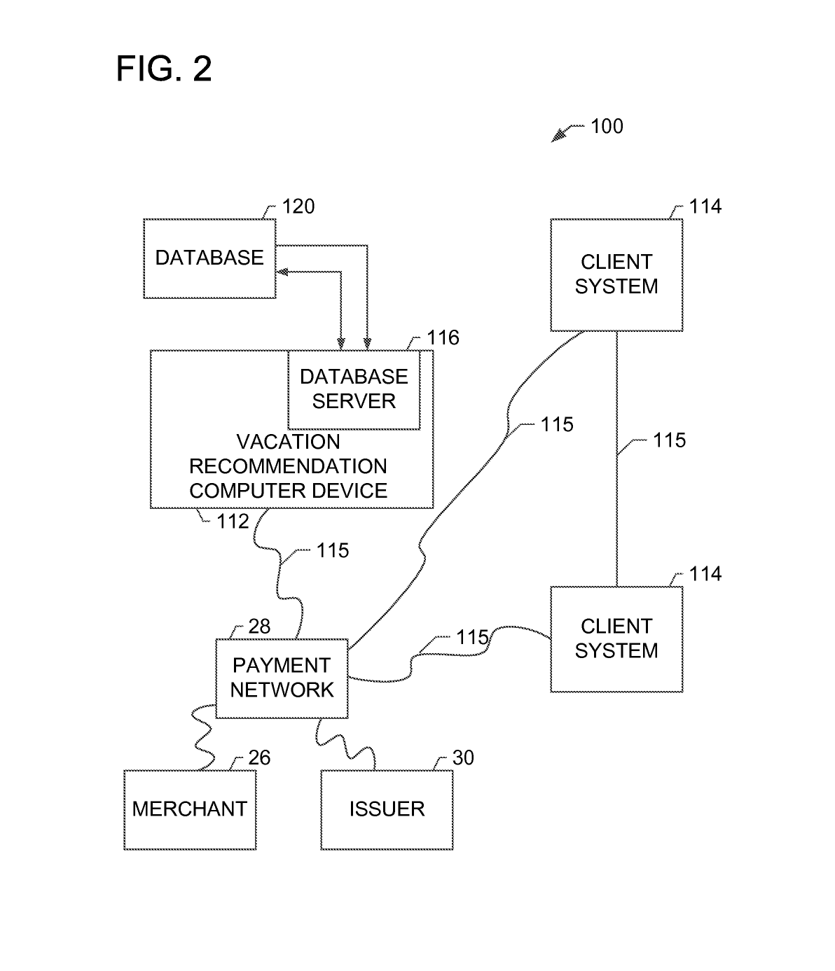

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including vacation recommendation computer device 112. In the example embodiment, interchange network 28 provides such transaction data (including vacation transaction data and ordinary transaction data as described above) and additional transaction data to vacation recommendation computer device. In alternative embodiments, any party may provide such data to vacation recommendation computer device 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, vacation recommendation computer device 112 may also be used to recommend merchants such as merchant 24 and/or a vacation package to consumers such as cardholder 22 using transaction data received from, for example, interchange network 28. For example, merchant 24 may provide vacation options that are responsive to a cardholder vacation profile for cardholder 22. For example, merchant 24 may be any suitable merchant of vacation options including, for example, a hotel, an airline, a resort, an excursion company, or any other similar merchant. As described above and herein, such merchant 24 may be associated with vacation options that are further associated with vacation attributes. However, in some examples, merchant 24 may be known or determined to have such vacation attributes and be accordingly recommended generally on such a basis. Although the systems described herein are not intended to be limited to facilitate such applications, the systems are described as such for exemplary purposes.

FIG. 2 is a simplified block diagram of an example computer system 100 used to recommend vacation options to cardholders in accordance with the present disclosure. In the example embodiment, system 100 is used for recommending vacation options to cardholders based on transaction data, as described herein. In other embodiments, the applications may reside on other computing devices (not shown) communicatively coupled to system 100, and may recommend vacation options to consumers using system 100.

More specifically, in the example embodiment, system 100 includes a vacation recommendation computer device 112, and a plurality of client sub-systems, also referred to as client systems 114, connected to vacation recommendation computer device 112. In one embodiment, client systems 114 are computers including a web browser, such that vacation recommendation computer device 112 is accessible to client systems 114 using the Internet. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1) as well as external systems used to store data (“vacation data resources”). Vacation recommendation computer device 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on vacation recommendation computer device 112 and can be accessed by potential users at one of client systems 114 by logging onto vacation recommendation computer device 112 through one of client systems 114. In an alternative embodiment, database 120 is stored remotely from vacation recommendation computer device 112 and may be non-centralized.

Database 120 may include a single database having separated sections or partitions, or may include multiple databases, each being separate from each other. Database 120 may store transaction data generated over the processing network including data relating to merchants, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authorization request data. Further, database 120 may function as a vacation database and substantially facilitate the analysis of ordinary transaction data and vacation transaction data to determine cardholder vacation characteristics. Similarly, database 120 may also function as a vacation database to facilitate the analysis of vacation options and determination of vacation attributes.

In the example embodiment, one of client systems 114 may be associated with acquirer bank 26 (shown in FIG. 1) while another one of client systems 114 may be associated with issuer bank 30 (shown in FIG. 1). Vacation recommendation computer device 112 may be associated with interchange network 28. In the example embodiment, vacation recommendation computer device 112 is associated with a network interchange, such as interchange network 28, and may be referred to as an interchange computer system. Vacation recommendation computer device 112 may be used for processing transaction data. In addition, client systems 114 may include a computer system associated with at least one of an online bank, a bill payment outsourcer, an acquirer bank, an acquirer processor, an issuer bank associated with a transaction card, an issuer processor, a remote payment system, customers and/or billers.

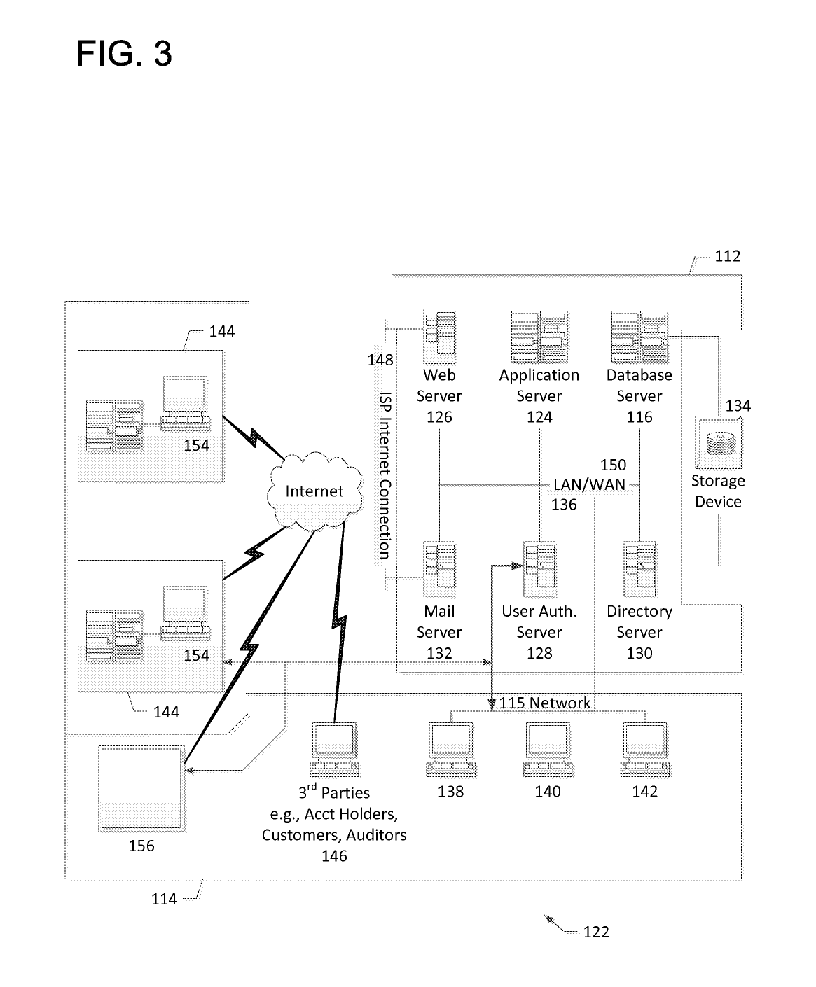

FIG. 3 is an expanded block diagram of an example embodiment of a computer server system architecture of a processing system 122 used to recommend vacation options to cardholders in accordance with one embodiment of the present disclosure. Components in system 122, identical to components of system 100 (shown in FIG. 2), are identified in FIG. 3 using the same reference numerals as used in FIG. 2. System 122 includes vacation recommendation computer device 112, client systems 114, and payment systems 118. Vacation recommendation computer device 112 further includes database server 116, a transaction server 124, a web server 126, a user authentication server 128, a directory server 130, and a mail server 132. A storage device 134 is coupled to database server 116 and directory server 130. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136 using network connection 115. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Vacation recommendation computer device 112 is configured to be operated by various individuals including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150. Vacation recommendation computer device 112 is also configured to be communicatively coupled to payment systems 118. Payment systems 118 include computer systems associated with merchant bank 26, interchange network 28, issuer bank 30 (all shown in FIG. 1), and interchange network 28. Additionally, payments systems 118 may include computer systems associated with acquirer banks and processing banks. Accordingly, payment systems 118 are configured to communicate with vacation recommendation computer device 112 and provide transaction data as discussed below.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with vacation recommendation computer device 112.

Also, in the example embodiment, web server 126, application server 124, database server 116, and/or directory server 130 may host web applications, and may run on multiple server systems 112. The term “suite of applications,” as used herein, refers generally to these various web applications running on server systems 112.

Furthermore, user authentication server 128 is configured, in the example embodiment, to provide user authentication services for the suite of applications hosted by web server 126, application server 124, database server 116, and/or directory server 130. User authentication server 128 may communicate with remotely located client systems, including a client system 156. User authentication server 128 may be configured to communicate with other client systems 138, 140, and 142 as well.

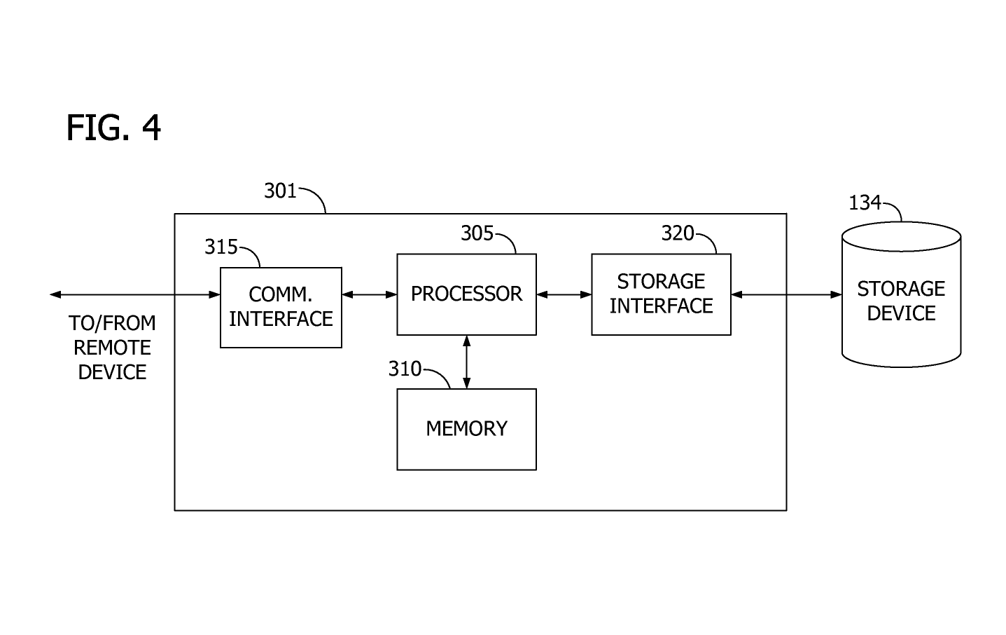

FIG. 4 illustrates an example configuration of a server system 301 such as vacation recommendation computer device 112 (shown in FIGS. 2 and 3). Server system 301 may include, but is not limited to, database server 116, transaction server 124, web server 126, user authentication server 128, directory server 130, and mail server 132. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

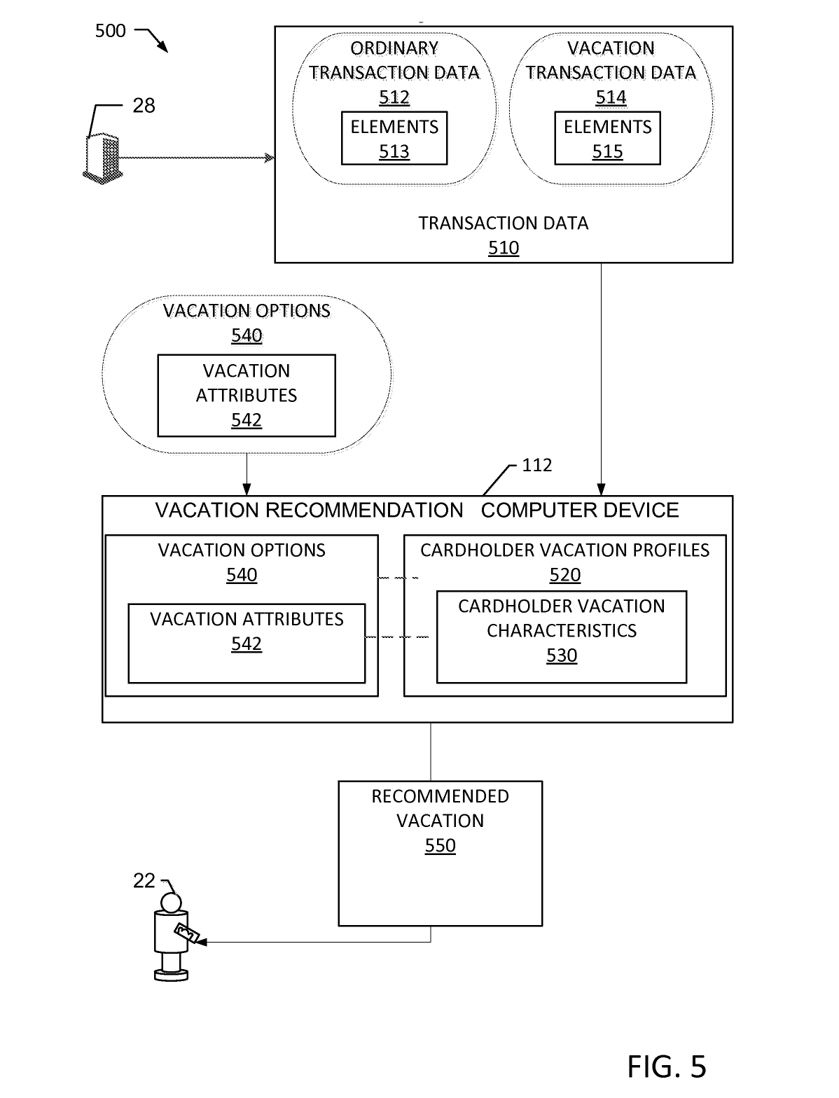

FIG. 5 is a simplified data flow diagram of recommending vacation options using the vacation recommendation computer device of FIGS. 2 and 3. As described above, vacation recommendation computer device 112 receives a plurality of transaction data 510. In the example embodiment, vacation recommendation computer device 112 receives transaction data 510 from interchange network 28.

Transaction data 510 may include ordinary transaction data 512 and vacation transaction data 514. Ordinary transaction data 512 further includes ordinary transaction data elements 513. Vacation transaction data 514 include vacation transaction data elements 515. Transaction data 510 may be described and represented as shown in Table 1, above.

Vacation recommendation computer device 112 uses transaction data 510 to determine cardholder vacation profiles 520. More specifically, vacation recommendation computer device 112 processes ordinary transaction data 512 including ordinary transaction data elements 513 and vacation transaction data 514 including vacation transaction data elements 515 to determine cardholder vacation characteristics 530. Cardholder vacation profiles 520 may be described and represented as shown in Table 2, above.

Vacation recommendation computer device 112 also receives vacation options 540. Vacation options 540 represent vacation packages or programs provided by merchants that may be of interest to cardholders. Vacation options 540 may include vacation attributes 542. In the example embodiment, vacation options 540 are received as file or any other suitable data that may describes at least one particular vacation program. Vacation attributes 542 may be described explicitly or implicitly. In some examples, vacation recommendation computer device 112 determines vacation attributes 542 using methods described above. Vacation options 540 may be represented and described as shown in Table 3, above.

Vacation recommendation computer device 112 identifies at least one vacation option 540 that is responsive to a cardholder by comparing cardholder vacation characteristics 530 to vacation attributes 542. Vacation recommendation computer device 112 recommends recommended vacation 550 to cardholder 22.

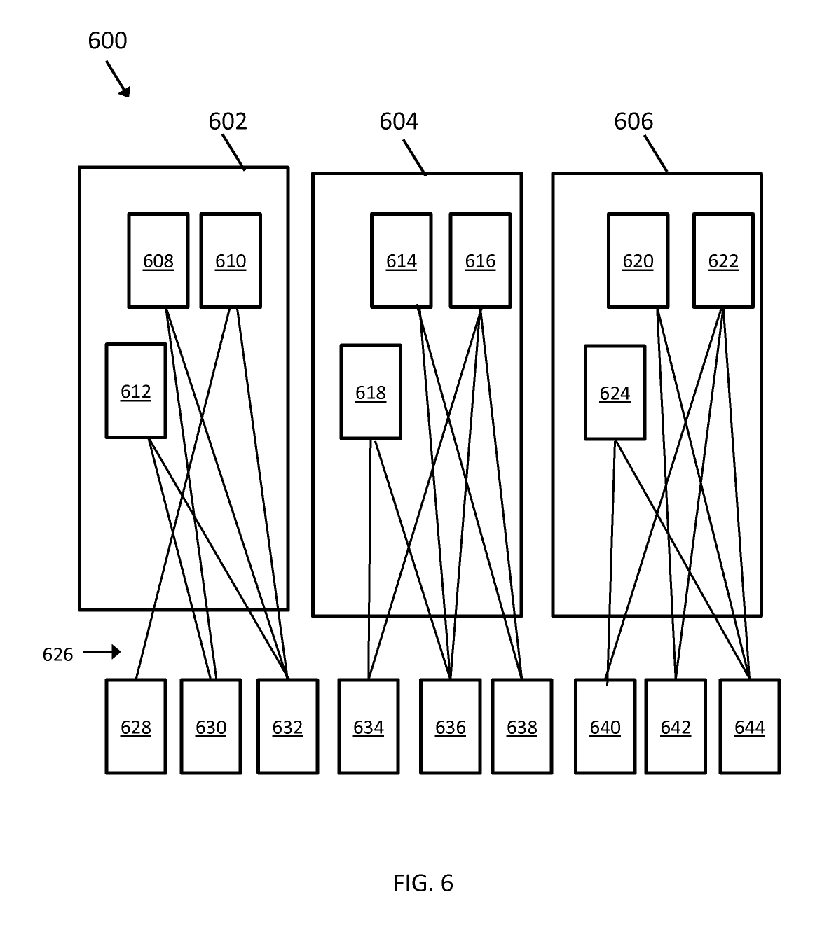

FIG. 6 is a block diagram of an example relationship 600 between cardholders 608, 610, 612, 614, 616, 618, 620, 622, and 624, merchants 628, 630, 632, 634, 636, 638, 640, 642, and 644, and categories 602, 604, 606 that the cardholders fall into based on purchases 626 from the merchants. More specifically, database 120 (FIG. 2) includes stored transaction data representing transactions 626 (i.e., purchases of goods) made by cardholders with merchants. For example, the stored transaction data indicates that first cardholder 608 made one or more purchases from second merchant 630 and third merchant 632. The stored transaction data also indicates that second cardholder 610 made one or more purchases from first merchant 628 and third merchant 632. Additionally, third cardholder 612 made one or more purchases from second merchant 630 and third merchant 632. Server system 202 associates with first cardholder 608, second cardholder 610, and third cardholder 612 with a first category 602, based at least in part on the fact that cardholders 608, 610, and 612 purchased from a common set of merchants (e.g., first merchant 628, second merchant 630, and third merchant 632). Additionally, server system 202 may base the categorization on specific goods purchased from the merchants, a price paid, or average price paid (“average transaction amount”) associated with the purchases, and/or a frequency of purchases associated with each of the cardholders 608, 610, and 612 during a predefined time period, such as one month. The categorization may be based on one or more underlying shared characteristics of cardholders 608, 610, and 612, such as a common income range, a common set of hobbies, a common life stage (e.g., a common marital status, a common age range, etc.), or other characteristics. In some implementations, server system 202 may identify what the one or more shared underlying characteristics are.

Similarly server system 202 associates fourth cardholder 614, fifth cardholder 616, and sixth cardholder 618 with a second category 604 based at least in part on purchases 626 made from merchants 634, 636, and 638. Likewise, server system 202 associates seventh cardholder 620, eighth cardholder 622, and ninth cardholder 624 with a third category 606 based at least in part on purchases 626 made by cardholders 620, 622, and 624 from merchants 640, 642, and 644. As should be appreciated from the description above, while first category 602 is associated with purchases made from first merchant 628, second merchant 630, and third merchant 632, in some implementations, one or more cardholders within first category 602 may also make purchases from one or more of merchants 634, 636, 638, 640, 642, and 644. More specifically, in some implementations, the categorization is based not solely on which merchants the cardholders purchase from, but may additionally or alternatively be based on one or more of specific goods purchased, purchase amounts, frequencies of purchases, and/or other factors.

As described in FIG. 6, such relationships 600 may be used to determine cardholder vacation profiles 520 and cardholder vacation characteristics 530. More specifically, relationships 600 may be used by vacation recommendation computer device 112 to compare merchants 628, 630, 632, 634, 636, 638, 640, 642, and 644, and determine categories 602, 604, 606 that the cardholders fall into based on purchases 626 from the merchants. Categories 602, 604, and 606 may be used to designate cardholder vacation characteristics 530 and cardholder vacation profiles 520 (shown in FIG. 5).

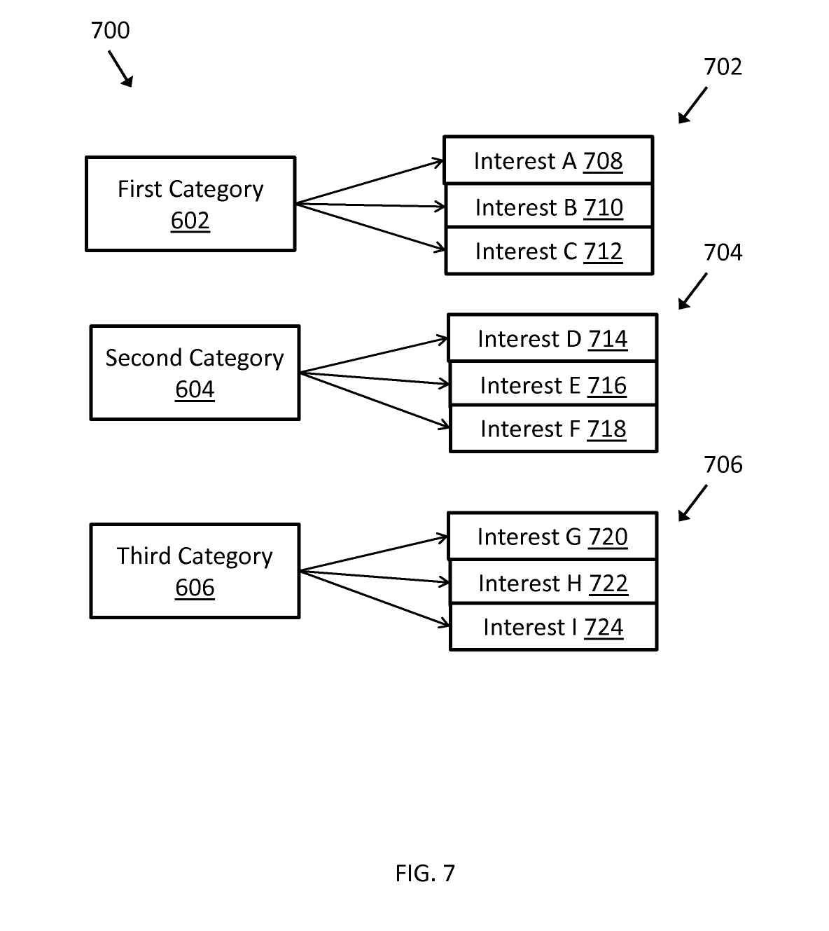

FIG. 7 is a block diagram of an example relationship 700 between categories 602, 604, and 606 and interests 708. 710, 712, 714, 716, 718, 720, 722, and 724 associated with the categories 602, 604, and 606. More specifically, first category 602 is associated with interest A 708, interest B 710, and interest C 712. Second category 604 is associated with interest D 714, interest E 716, and interest F 718. Third category 606 is associated with interest G 720, interest H 722, and interest I 724. Each interest represents a set of goods that merchants, such as merchants 628, 630, 632, 634, 636, 638, 640, 642, and/or 644 sell. Importantly, while a particular cardholder, such as second cardholder 610 may not have purchased any goods from second merchant 630, which sells luxury vehicles, given that second cardholder 610 is in first category 602, second cardholder 610 likely shares many of the same interests as first cardholder 608 and third cardholder 612. In other words, while the stored transaction data in database 208 may indicate that second cardholder 610 has purchased from first merchant 628, which sells golf equipment and corresponds with interest A 708 (i.e., golf), and from third merchant 632, which sells business suits and corresponds with interest C 712 (i.e., business attire), second cardholder 610 is likely to also share interest B 710, which is luxury vehicles.

In a similar manner, FIG. 7 shows relationship 700 that may be used to determine cardholder vacation profiles 520 and cardholder vacation characteristics 530. More specifically, relationships 700 may be used by vacation recommendation computer device 112 to compare categories 602, 604, and 606 and interests 708, 710, 712, 714, 716, 718, 720, 722, and 724 associated with the categories 602, 604, and 606. Interests 708, 710, 712, 714, 716, 718, 720, 722, and 724 may be used to designate cardholder vacation characteristics 530 and cardholder vacation profiles 520 (shown in FIG. 5).

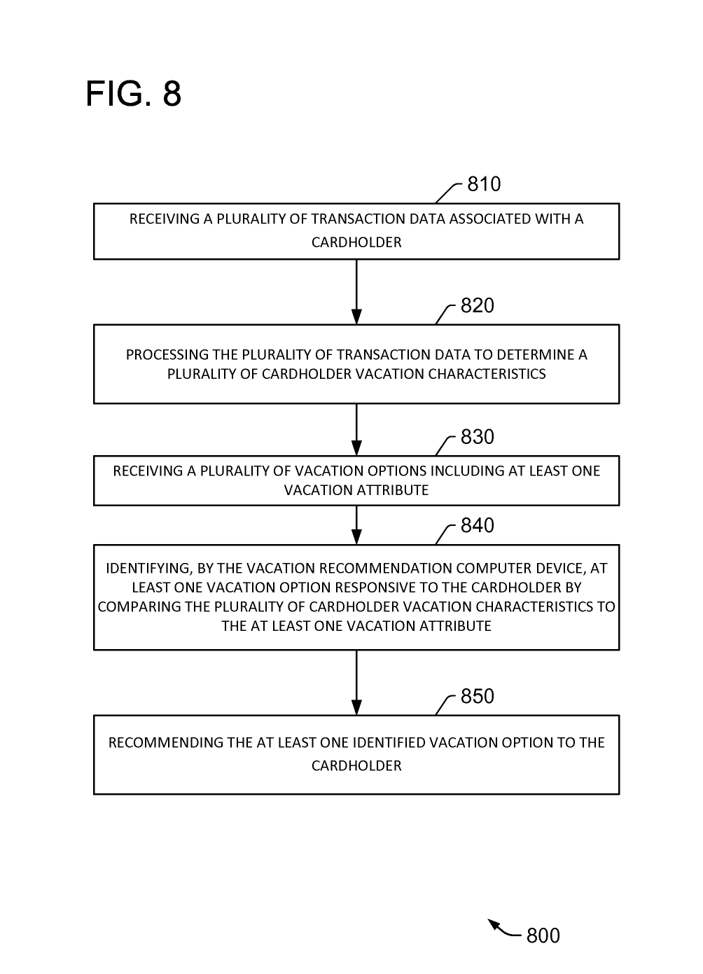

FIG. 8 is a simplified diagram of an example method 800 of recommending vacation options using the vacation recommendation computer device of FIGS. 2 and 3. Method 800 is implemented by vacation recommendation computer device 112 (shown in FIG. 2). Vacation recommendation computer device 112 receives 810 a plurality of transaction data associated with a cardholder. Vacation recommendation computer device 112 also processes 820 the plurality of transaction data to determine a plurality of cardholder vacation characteristics. Vacation recommendation computer device 112 additionally receives 830 a plurality of vacation options including at least one vacation attribute. Vacation recommendation computer device 112 also identifies 840 at least one vacation option that is responsive to the cardholder by comparing the plurality of cardholder vacation characteristics to the at least one vacation attribute. Vacation recommendation computer device 112 also recommends 850 at least one identified vacation option to the cardholder.

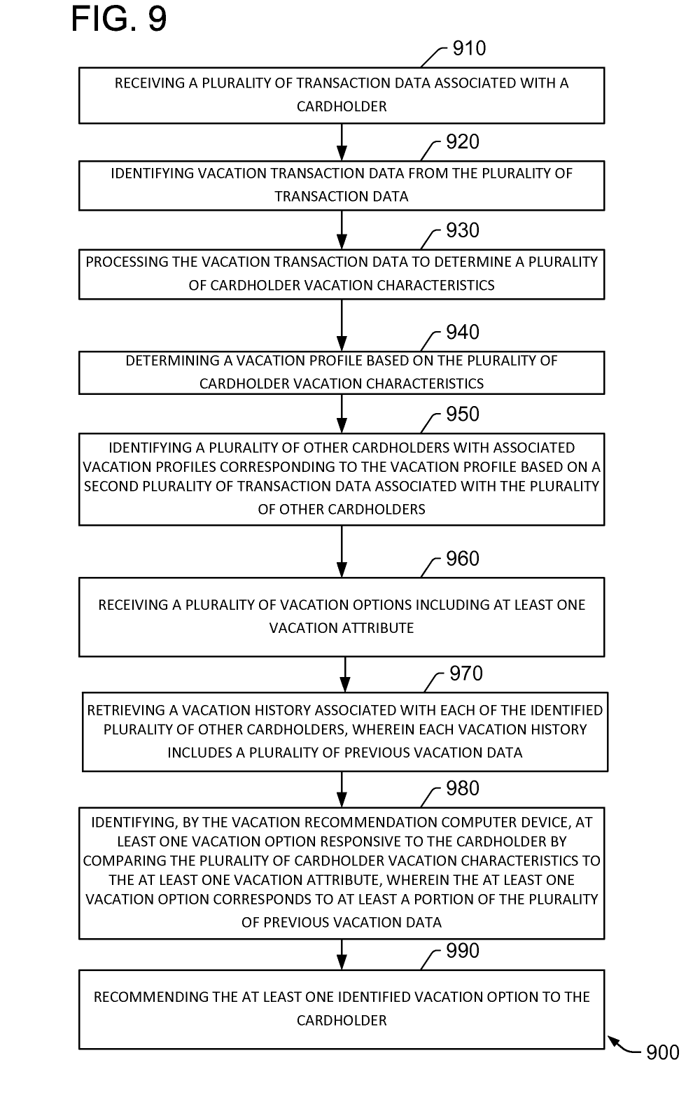

FIG. 9 is a simplified diagram of a further example method of recommending vacation options using the vacation recommendation computer device of FIGS. 2 and 3. Method 900 is implemented by vacation recommendation computer device 112 (shown in FIG. 2). Vacation recommendation computer device 112 receives 910 a plurality of transaction data associated with a cardholder. Vacation recommendation computer device 112 also identifies 920 vacation transaction data from the plurality of transaction data. Vacation recommendation computer device 112 further processes 930 the vacation transaction data to determine a plurality of cardholder vacation characteristics. Vacation recommendation computer device 112 also determines 940 a vacation profile based on the plurality of cardholder vacation characteristics. Vacation recommendation computer device 112 further identifies 950 a plurality of other cardholders with associated vacation profiles corresponding to the vacation profile based on a second plurality of transaction data associated with the plurality of other cardholders. Vacation recommendation computer device 112 also receives 960 a plurality of vacation options including at least one vacation attribute. Vacation recommendation computer device 112 further retrieves 970 a vacation history associated with each of the identified plurality of other cardholders, wherein each vacation history includes a plurality of previous vacation data. Vacation recommendation computer device 112 also identifies 980 at least one vacation option responsive to the cardholder by comparing the plurality of cardholder vacation characteristics to the at least one vacation attribute, wherein the at least one vacation option corresponds to at least a portion of the plurality of previous vacation data. Vacation recommendation computer device 112 also recommends 990 at least one identified vacation option to the cardholder.

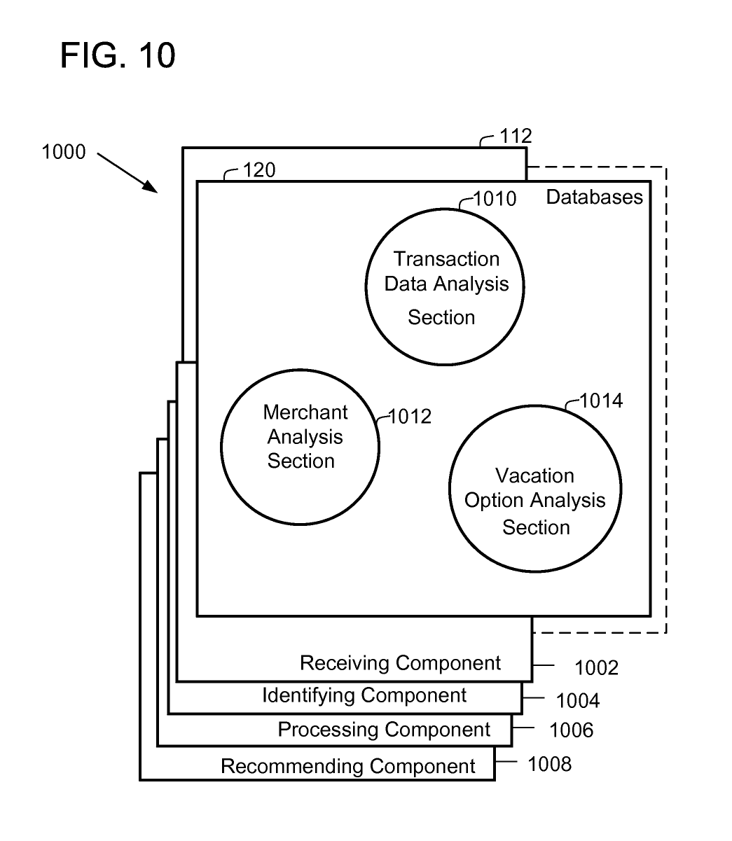

FIG. 10 is a diagram of components of one or more example computing devices that may be used in the environment shown in FIG. 6. FIG. 10 further shows a configuration of databases including at least database 120 (shown in FIG. 1). Database 120 is coupled to several separate components within vacation recommendation computer device 112, which perform specific tasks.

Vacation recommendation computer device 112 includes a receiving component 1002 for receiving transaction data (including ordinary transaction data and vacation transaction data) and vacation options. Vacation recommendation computer device 112 also includes an identifying component 1004 for identifying vacation transaction data from transaction data and identifying a vacation option responsive to the cardholder. Vacation recommendation computer device 1006 also includes a processing component 1006 for processing the vacation transaction data and ordinary transaction data to determine a plurality of cardholder vacation characteristics. Vacation recommendation computer device 112 also includes a recommending component 1008 for recommending the identified vacation option to the cardholder.

In an exemplary embodiment, database 120 is divided into a plurality of sections, including but not limited to, a transaction data analysis section 1010, a merchant analysis section 1012, and a vacation option analysis section 1014. These sections within database 120 are interconnected to update and retrieve the information as required.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for recommending vacation options based on historical vacation data, the method implemented by a vacation recommendation computer device in communication with a memory, the method comprising:
receiving a plurality of transaction data associated with a cardholder;
identifying, by the vacation recommendation computer device, vacation transaction data from the plurality of transaction data;
processing the vacation transaction data to determine a plurality of cardholder vacation characteristics;
determining a vacation profile based on the plurality of cardholder vacation characteristics;
identifying a plurality of other cardholders with associated vacation profiles corresponding to the vacation profile based on a second plurality of transaction data associated with the plurality of other cardholders;
receiving a plurality of vacation options including at least one vacation attribute; retrieving a vacation history associated with each of the identified plurality of other cardholders, wherein each vacation history includes a plurality of previous vacation data;
identifying, by the vacation recommendation computer device, at least one vacation option responsive to the cardholder by comparing the plurality of cardholder vacation characteristics to the at least one vacation attribute, wherein the at least one vacation option corresponds to at least a portion of the plurality of previous vacation data; and
recommending the at least one identified vacation option to the cardholder.

2. The method of claim 1, wherein identifying vacation transaction data further comprises:
determining a primary region associated with the cardholder based on the plurality of transaction data, wherein the primary region represents a location in which the cardholder spends a substantial amount of time; and
identifying transaction data associated with card-present transactions that are initiated by the cardholder at a merchant having a merchant location outside of the primary region.

3. The method of claim 1, wherein identifying vacation transaction data further comprises further comprises:
identifying a plurality of patronized merchant categories associated with each transaction included within the transaction data for the cardholder;
defining vacation merchant categories included within the plurality of patronized merchant categories wherein vacation merchant categories are categories of merchants that are associated with vacation travel; and
identifying transaction data included within the vacation merchant categories as vacation transaction data.

4. The method of claim 1, wherein identifying vacation transaction data further comprises further comprises:
identifying a vacation region of interest for the cardholder based on the vacation transaction data, wherein the vacation region of interest represents at least one geographic location in which the cardholder is interested in vacation travel.

5. The method of claim 1, wherein identifying vacation transaction data further comprises further comprises:
identifying a cardholder vacation schedule based on the vacation transaction data.

6. The method of claim 1, further comprising:
determining a cardholder vacation budget associated with the at least one vacation option.

7. The method of claim 1, further comprising:
determining a primary purpose associated with the at least one vacation option.

8. A vacation recommendation computer device used to recommend vacation options based on historical vacation data, the vacation recommendation computer device comprising:
a processor; and
a memory coupled to said processor, said processor configured to:
receive a plurality of transaction data associated with a cardholder;
identify vacation transaction data from the plurality of transaction data;
process the vacation transaction data to determine a plurality of cardholder vacation characteristics;
determine a vacation profile based on the plurality of cardholder vacation characteristics;
identify a plurality of other cardholders with associated vacation profiles corresponding to the vacation profile based on a second plurality of transaction data associated with the plurality of other cardholders;
receive a plurality of vacation options including at least one vacation attribute;
retrieve a vacation history associated with each of the identified plurality of other cardholders, wherein each vacation history includes a plurality of previous vacation data;
identify at least one vacation option responsive to the cardholder by comparing the plurality of cardholder vacation characteristics to the at least one vacation attribute, wherein the at least one vacation option corresponds to at least a portion of the plurality of previous vacation data; and
recommend the at least one identified vacation option to the cardholder.

9. A vacation recommendation computer device in accordance with claim 8 wherein the processor is further configured to:
determine a primary region associated with the cardholder based on the plurality of transaction data, wherein the primary region represents a location in which the cardholder spends a substantial amount of time; and
identify transaction data associated with card-present transactions that are initiated by the cardholder at a merchant having a merchant location outside of the primary region.

10. A vacation recommendation computer device in accordance with claim 8 wherein the processor is further configured to:
identify a plurality of patronized merchant categories associated with each transaction included within the transaction data for the cardholder;
define vacation merchant categories included within the plurality of patronized merchant categories wherein vacation merchant categories are categories of merchants that are associated with vacation travel; and
identify transaction data included within the vacation merchant categories as vacation transaction data.

11. A vacation recommendation computer device in accordance with claim 8 wherein the processor is further configured to:
identify a vacation region of interest for the cardholder based on the vacation transaction data, wherein the vacation region of interest represents at least one geographic location in which the cardholder is interested in vacation travel.

12. A vacation recommendation computer device in accordance with claim 8 wherein the processor is further configured to:
identify a cardholder vacation schedule based on the vacation transaction data.

13. A vacation recommendation computer device in accordance with claim 8 wherein the processor is further configured to:
determine a cardholder vacation budget associated with the at least one vacation option.

14. A vacation recommendation computer device in accordance with claim 8 wherein the processor is further configured to:
determine a primary purpose associated with the at least one vacation option.

15. Computer-readable storage media for recommending vacation options based on historical vacation data, the computer-readable storage media having computer-executable instructions embodied thereon, wherein, when executed by at least one processor, the computer-executable instructions cause the processor to:
receive a plurality of transaction data associated with a cardholder;
identify vacation transaction data from the plurality of transaction data;
process the vacation transaction data to determine a plurality of cardholder vacation characteristics;
determine a vacation profile based on the plurality of cardholder vacation characteristics;
identify a plurality of other cardholders with associated vacation profiles corresponding to the vacation profile based on a second plurality of transaction data associated with the plurality of other cardholders;
receive a plurality of vacation options including at least one vacation attribute;
retrieve a vacation history associated with each of the identified plurality of other cardholders, wherein each vacation history includes a plurality of previous vacation data;
identify at least one vacation option responsive to the cardholder by comparing the plurality of cardholder vacation characteristics to the at least one vacation attribute, wherein the at least one vacation option corresponds to at least a portion of the plurality of previous vacation data; and
recommend the at least one identified vacation option to the cardholder.

16. The computer-readable storage media in accordance with claim 15, wherein the computer-executable instructions cause the processor to:
determine a primary region associated with the cardholder based on the plurality of transaction data, wherein the primary region represents a location in which the cardholder spends a substantial amount of time; and
identify transaction data associated with card-present transactions that are initiated by the cardholder at a merchant having a merchant location outside of the primary region.

17. The computer-readable storage media in accordance with claim 15, wherein the computer-executable instructions cause the processor to:
identify a plurality of patronized merchant categories associated with each transaction included within the transaction data for the cardholder;
define vacation merchant categories included within the plurality of patronized merchant categories wherein vacation merchant categories are categories of merchants that are associated with vacation travel; and
identify transaction data included within the vacation merchant categories as vacation transaction data.

18. The computer-readable storage media in accordance with claim 15, wherein the computer-executable instructions cause the processor to:
identify a vacation region of interest for the cardholder based on the vacation transaction data, wherein the vacation region of interest represents at least one geographic location in which the cardholder is interested in vacation travel.

19. The computer-readable storage media in accordance with claim 15, wherein the computer-executable instructions cause the processor to:
identify a cardholder vacation schedule based on the vacation transaction data.

20. The computer-readable storage media in accordance with claim 15, wherein the computer-executable instructions cause the processor to:
determine a cardholder vacation budget associated with the at least one vacation option.
